(19) United States
(12) Patent Application Publication
(10) Pub. No.: US 2015/0174453 A1
(43) Pub. Date: Jun. 25, 2015

(54) GOLF BALLS WITH COVERS OF HIGH ACID IONOMERS

(71) Applicant: E I DU PONT DE NEMOURS AND COMPANY, Wilmington, DE (US)

(72) Inventors: JOHN P. BISHOP, WILMINGTON, DE (US); JAMES R. DE GARAVILLA, SILSBEE, TX (US); STEVEN C. PESEK, ORANGE, TX (US); CHARLES ANTHONY SMITH, VIENNA, WV (US); SHANNON D. MEERSCHEIDT, BRIDGE CITY, TX (US); W ALEXANDER SHAFFER, ORANGE, TX (US)

(21) Appl. No.: 14/573,170

(22) Filed: Dec. 17, 2014

Related U.S. Application Data
(60) Provisional application No. 61/918,138, filed on Dec. 19, 2013.

(51) Int. Cl. A63B 37/00; C08F 22/10

(52) U.S. Cl. CPC A63B 37/0031; A63B 37/0059; C08F 22/10

(57) ABSTRACT

Disclosed is a golf ball comprising a cover prepared from an ionomer composition comprising a high acid ionomer comprising about 15 to about 30 weight % of copolymerized units of a C₃₋₈ α,β-ethylenically unsaturated carboxylic acid and about 3 to about 13 weight % of copolymerized units of vinyl acetate, alkyl acrylate or alkyl methacrylate.

### CROSS REFERENCE TO RELATED APPLICATION

This application claims priority under 35 U.S.C. §119(e) from U.S. Provisional Patent Application No. 61/918,138, filed Dec. 19, 2013, hereby incorporated herein by reference in its entirety.

### FIELD OF THE INVENTION

The invention relates to golf balls with covers prepared from high acid ionomer terpolymers.

### BACKGROUND OF THE INVENTION

Several patents and publications are cited in this description in order to more fully describe the state of the art to which this invention pertains. The entire disclosure of each of these patents and publications is incorporated by reference herein.

Premium golf balls include wound balls, two-piece balls and multilayered balls. Wound balls may have a spherical molded center, elastomeric thread-like material wound around the center, and either a thermoplastic or thermoset cover. Two-piece balls have a spherical molded core covered with a thin layer of thermoplastic or thermoset material. Multilayered balls have a spherical molded core, a cover, and one or more intermediate layers between the core and the cover.

Ionomeric resins (ionomers) are useful materials for the construction of golf balls, among other things. Ionomers are ionic copolymers that are obtained after copolymerization of an olefin such as ethylene with an unsaturated carboxylic acid, such as acrylic acid (AA), methacrylic acid (MAA), or maleic acid, and optionally softening monomers. Neutralizing agents—which for the purposes of this application are ionic compounds containing metal cations such as sodium or zinc ions—are used to neutralize at least some portion of the acidic groups in the copolymer resulting in a thermoplastic resin exhibiting enhanced properties. For example, golf balls constructed using ionomeric materials have improved resilience and durability as compared with balata ball construction. As a result of their resilience, toughness, durability and flight characteristics, various ionomeric resins sold by E. I. DuPont de Nemours & Company under the trademark “Surlyn®” and by the Exxon Corporation under the trademark “Escor®” and the tradename “Iotek” have become materials of choice for the construction of golf balls over the traditional balata (trans polyisoprene, natural or synthetic) rubbers. The softer balata covers, although exhibiting enhanced playability properties, lack the durability necessary for repetitive play. However, the advantages gained in increased durability of the ionomeric covers have been offset to some degree by their decreased playability. This is because the durable ionomeric resins tend to be very hard when used for golf ball cover construction, and thus lack the degree of softness required to impart the spin necessary to control the ball in play.

For example, golf balls with ionomer-containing covers have been produced by injection molding. See, e.g.; U.S. Pat. Nos. 4,714,253; 5,439,227; 5,452,898; 5,553,852; 5,752,889; 5,782,703; 5,782,707; 5,803,833; 5,807,192; 6,179,732; 6,699,027; 7,005,098; 7,128,864; 7,201,672; and U.S. Patent Application Publications 2006/0043632; 2006/0273485; and 2007/0282069.

Commercial ionomers derived from dipolymers have not been able to produce the desirable properties of soft balata covers, for example, playability (that is, “spin”). These are properties desired by the more skilled golfer.

Terpolymers made from copolymerization of (a) an olefin, such as ethylene (b) an unsaturated carboxylic acid and (c) other comonomers, such as alkyl acrylates and/or alkyl methacrylates, provide “softer” resins that can be neutralized to form softer ionomers. U.S. Pat. No. 4,337,947 discloses terpolymer ionomer compositions for use in golf balls with covers comprising a blend of at least one ionomer and at least one polyester elastomer. U.S. Pat. No. 4,690,981 discloses terpolymer ionomers for use in golf balls with reduced short chain branching prepared using relatively low reactor temperatures and proper selection of comonomers for low temperature performance.

Previously, terpolymer ionomers used in golf ball covers had relatively low levels of acid and relatively high levels of alkyl (meth)acrylate in the base copolymer. Ionomers of these terpolymers are generally considered to be too soft to be used in golf ball covers alone, so they have been mixed with harder dipolymer ionomers to provide harder covers (see for example U.S. Pat. Nos. 4,884,814 and 5,120,791). U.S. Pat. No. 5,691,418 also describes blends of terpolymer ionomers and dipolymer ionomers that provide a combination of high resilience at given levels of PGA compressibility.

Soft ionomers also include so-called “bimodal” ionomer compositions. Bimodal ionomer compositions are described in U.S. Pat. Nos. 6,562,906; 6,762,246; 7,037,967; 7,273,903, 7,488,778, 8,193,283 and 8,410,220. U.S. Patent Application Publication 2011/306,442 describes blends of soft bimodal ionomer compositions with harder dipolymer ionomers to provide harder covers with a better combination of hardness and scuff resistance.

While golf balls formed from hard-soft ionomer blends have appropriate hardness, they tend to become scuffed more readily than covers made of hard ionomer alone, or even of soft ionomer alone. Thus, it is desirable to prepare compositions suitable for use in golf balls, particularly in covers, that provide a combination of suitable hardness and good scuff resistance.

### SUMMARY OF THE INVENTION

The invention provides a golf ball comprising a core and a cover and optionally at least one intermediate layer positioned between the core and the cover, wherein the cover comprises, consists essentially of, or is prepared from an ionomer of an ethylene acid copolymer comprising or consisting essentially of copolymerized units of ethylene, about 15 to about 30 weight % of copolymerized units of a C₃₋₈ α,β-ethylenically unsaturated carboxylic acid, and about 3 to about 13 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 30%; and

The composition has Shore D hardness of 45 to 65 (measured in accordance with ASTM D-2240 on a standard test plaque) and flex modulus of 120 to 600 kpsi (measured in accordance with ASTM D-790B), with very good scuff resistance, wherein a golf ball cover made with the described composition has a scuff resistance of not greater than about 2.0 out of 5.

### DETAILED DESCRIPTION OF THE INVENTION

The following definitions apply to the terms as used throughout this specification, unless otherwise limited in specific instances. What follows “is” may be considered as definition.

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Unless stated otherwise, all percentages, parts, ratios, etc., are by weight.

Use of “a” or “an” are employed to describe elements and components of the invention. This is done merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting.

The terms “comprises,” “comprising,” “includes,” “including,” “containing,” “characterized by,” “has,” “having”, “produced from”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith.

The transitional phrase “consisting essentially of” limits the scope of a claim to the specified materials or steps and those that do not materially affect the basic and novel characteristic(s) of the claimed invention. Optional additives as defined herein, at levels that are appropriate for such additives, and minor impurities are not excluded from a composition by the term “consisting essentially of”. Moreover, such additives may possibly be added via a masterbatch that may include other polymers as carriers, so that minor amounts (less than 5 or less than 1 weight %) of polymers other than those recited may be present. Therefore, the term “consisting essentially of” in relation to polymeric compositions is to indicate that substantially (greater than 95 weight % or greater than 99 weight %) the only polymer(s) present in a component layer is the polymer(s) recited.

The term “or”, as used herein, is inclusive; that is, the phrase “A or B” means “A, B, or both A and B”. More specifically, a condition “A or B” is satisfied by any one of the following: A is true (or present) and B is false (or not present); A is false (or not present) and B is true (or present); or both A and B are true (or present). Exclusive “or” is designated herein by terms such as “either A or B” and “one of A or B”, for example.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. When “about” is used in describing a value or an end-point of a range, the disclosure should be understood to include the specific value or end-point referred to.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof. “Dipolymer” refers to polymers consisting essentially of, or consisting of, two monomers and “terpolymer” refers to polymers consisting essentially of, or consisting of, three monomers.

The term “acid copolymer” as used herein refers to a polymer comprising copolymerized units of an α-olefin, an α,β-ethylenically unsaturated carboxylic acid, and optionally other suitable comonomer(s) such as, an α,β-ethylenically unsaturated carboxylic acid ester.

The term “(meth)acrylic”, as used herein, alone or in combined form, such as “(meth)acrylate”, refers to acrylic or methacrylic, for example, “acrylic acid or methacrylic acid”, or “alkyl acrylate or alkyl methacrylate”.

The term “ionomer” as used herein refers to a polymer that comprises ionic groups that are carboxylate salts, for example, ammonium carboxylates, alkali metal carboxylates, alkaline earth carboxylates, transition metal carboxylates and/or combinations of such carboxylates. Such polymers are generally produced by partially or fully neutralizing the carboxylic acid groups of precursor or parent polymers that are acid copolymers, as defined herein, for example by reaction with a base. An example of an alkali metal ionomer as used herein is a zinc/sodium mixed ionomer (or zinc/sodium neutralized mixed ionomer), for example a copolymer of ethylene and methacrylic acid wherein all or a portion of the carboxylic acid groups of the copolymerized methacrylic acid units are in the form of zinc carboxylates and sodium carboxylates.

Finally, although methods and materials similar or equivalent to those described herein can be used in the practice or testing of the invention, suitable methods and materials are described herein. Moreover, the materials, methods, and examples herein are illustrative only and, except as specifically stated, are not intended to be limiting.

### Acid Copolymers

The ethylene acid copolymer components of the composition are preferably “direct” or “random” acid copolymers, in which the polymers are polymerized by adding all monomers simultaneously, as opposed to grafted copolymers in which a comonomer is grafted onto an existing polymer.

They are preferably an α-olefin, particularly ethylene, α,β-ethylenically unsaturated carboxylic acid, particularly acrylic acid or methacrylic acid, copolymer, and containing a third softening monomer. “Softening” means that the polymer is made less crystalline.

The acid copolymer may be described as an E/X/Y terpolymer where E represents copolymerized units of ethylene, X represents copolymerized units of a C₃₋₈ α,β-ethylenically unsaturated carboxylic acid, preferably acrylic acid or methacrylic acid, and Y represents copolymerized units of a softening comonomer selected from alkyl acrylate or alkyl methacrylate, wherein the alkyl groups have from 1 to 8 carbon atoms, or vinyl acetate. X is present in an amount of about 15 to about 30 (or about 15 to 25 or about 20 to 25) weight % of the E/X/Y polymer, and Y is present in an amount from a lower limit of about 2, about 3, or about 5 to an upper limit of about 9, about 10, about 11, about 12 or about 13 weight % of the E/X/Y copolymer. The weight percentages of the copolymerized units are based on the total weight of the ethylene acid copolymer, and the sum of the weight percentages of the copolymerized units is 100 weight %.

Preferred are terpolymers and compositions comprising the terpolymers wherein the copolymerized comonomers of C₃₋₈ α,β ethylenically unsaturated carboxylic acid are acrylic acid or methacrylic acid and the copolymerized comonomers of C₃₋₈ α,β ethylenically unsaturated carboxylic acid esters are C₁₋₄ alkyl esters of acrylic acid or methacrylic acid. More preferred are ethylene/acrylic acid/alkyl acrylate terpolymers and ethylene/methacrylic acid/alkyl acrylate terpolymers.

Included are E/X/Y terpolymers in which X represents copolymerized units of acrylic acid present in an amount of about 15 to about 30% of the E/X/Y terpolymer and Y represents copolymerized units of an alkyl acrylate and is present in an amount from 3 to 11% of the E/X/Y terpolymer. Suitable terpolymers include without limitation ethylene/acrylic acid/methyl acrylate, ethylene/acrylic acid/ethyl acrylate, ethylene/acrylic acid/n-butyl acrylate, ethylene/acrylic acid/iso-butyl acrylate. Preferred terpolymers include ethylene/acrylic acid/n-butyl acrylate terpolymers and ethylene/acrylic acid/i-butyl acrylate terpolymers.

Included are E/X/Y terpolymers in which X represents copolymerized units of methacrylic acid present in an amount of about 15 to about 30% of the E/X/Y terpolymer and Y represents copolymerized units of an alkyl acrylate and is present in an amount from 3 to 11% of the E/X/Y terpolymer. These terpolymers include without limitation ethylene/methacrylic acid/methyl acrylate, ethylene/methacrylic acid/ethyl acrylate, ethylene/methacrylic acid/n-butyl acrylate, and ethylene/methacrylic acid/iso-butyl acrylate, notably ethylene/methacrylic acid/n-butyl acrylate terpolymers and ethylene/methacrylic acid/i-butyl acrylate terpolymers.

These E/X/Y copolymers preferably have melt indices (MI) from about 0.1 to about 600, or from about 25 to about 300, or from about 60 to about 250 g/10 min.

While any terpolymer with the recited amounts of X and Y can be considered for use, one that has found particular use in this invention is an acid terpolymer comprising copolymerized units of about 67.5 weight % of ethylene, about 22.5 weight % of methacrylic acid and about 10 weight % of n-butyl acrylate. Also of note is an acid terpolymer comprising copolymerized units of about 68.5 weight % of ethylene, about 21.5 weight % of methacrylic acid and about 10 weight % of n-butyl acrylate.

Methods of preparing ethylene acid copolymers are known. They may be prepared as described in U.S. Pat. No. 4,351,931. Ethylene acid copolymers also may be prepared in continuous polymerizers by use of “co-solvent technology” as described in U.S. Pat. No. 5,028,674.

The precursor acid copolymers may be synthesized by methods that are described in detail in U.S. Pat. Nos. 3,404,134; 6,518,365; 8,399,096, and references cited therein. In one embodiment, a method described in U.S. Pat. No. 8,399,096 is used, and a sufficiently high level and complementary amount of the alkyl (meth)acrylate ester is present in the reaction mixture.

### Ionomers

Unmodified, melt processible ionomers may be prepared from acid copolymers described above by methods known in the art. By “unmodified”, it is meant that the ionomers are not blended with any material that has been added for the purpose of modifying the properties of the unblended ionomer. Ionomers include partially neutralized acid copolymers, particularly copolymers prepared from copolymerization of ethylene, acrylic acid or methacrylic acid and optionally additional comonomers such as alkyl acrylates or alkyl methacrylates. The unmodified ionomers may be neutralized to any level that does not result in an intractable (not melt processible) polymer that does not have useful physical properties. The level of neutralization can be adjusted to provide a resin with a desired melt index, for example from about 1 to about 10 g/10 min. The desired degree of neutralization can also depend on other factors such as base resin composition such as acid content and base resin melt index prior to neutralization. Preferably, about 15 to about 50%, more preferably about 15 to about 30% of the acid moieties of the acid copolymer are neutralized to form carboxylate groups. Preferred cations for the carboxylate groups include alkali metal cations, alkaline earth metal cations, transition metal cations, and combinations of two or more of these metal cations.

Cations useful in making the unmodified ionomers include lithium, sodium, potassium, magnesium, aluminum, calcium, barium, or zinc, or combinations of such cations. Zinc, sodium and combinations thereof are more preferred.

While any terionomer with the recited amounts of X and Y can be considered for use, one that has found particular use in this invention comprises an acid terpolymer comprising copolymerized units of about 67.5 weight % of ethylene, about 22.5 weight % of methacrylic acid and about 10 weight % of n-butyl acrylate, where the acid terpolymer is neutralized with sodium such that the resin has a melt flow index from about 1 to about 10 g/10 min, preferably about 2 to about 5 g/10 min after neutralization. Of note is an ionomer comprising an acid terpolymer comprising copolymerized units of about 68.5 weight % of ethylene, about 21.5 weight % of methacrylic acid and about 10 weight % of n-butyl acrylate.

### Process for Making the Ionomer Composition

To obtain the ionomers useful in the acid copolymer compositions described herein, the acid copolymer resins are neutralized with a base so that the carboxylic acid groups in the acid copolymer resin react to form carboxylate groups. Preferably, the carboxylic acid groups in the acid copolymer are neutralized to a level of about 1 to about 90%, or about 5% to about 80%, or about 10% to about 70%, or about 15% to about 60%, or about 20% to about 50%, or up to about 20%, or up to about 17%, or up to about 15%, based on the total carboxylic acid content of the precursor acid copolymers as calculated or measured for the non-neutralized precursor acid copolymers.

Any stable cation and any combination of two or more stable cations are believed to be suitable as counterions to the carboxylate groups in the ionomer. The amount of ionic compound capable of neutralizing a certain number of acidic groups may be determined by simple stoichiometric principles. When an amount of base sufficient to neutralize a target amount of acid moieties in the acid copolymer is made available in a melt blend, it is assumed that, in aggregate, the indicated level of nominal neutralization is achieved. Divalent and monovalent cations, such as cations of alkali metals, alkaline earth metals, and some transition metals, are preferred. Zinc cations are preferred divalent ions, and sodium cations are preferred monovalent ions. In one embodiment, the base is a sodium ion-containing base, to provide a sodium ionomer wherein about 1% to about 50% or about 5% to about 30%, or about 10% to about 20% of the hydrogen atoms of the carboxylic acid groups of the precursor acid are replaced by sodium cations. In another embodiment, the base is a zinc ion-containing base, to provide a zinc ionomer wherein about 1% to about 50% or about 5% to about 30%, or about 10% to about 20% of the hydrogen atoms of the carboxylic acid groups of the precursor acid are replaced by a charge-equivalent quantity of zinc cations.

The resulting neutralized ionomer may have a MFR of about 250 g/10 min or less, or about 100 g/10 min or less, or about 50 g/10 min or less, or of about 25 g/10 min or less, or about 0.7 to about 25 g/10 min or less, or about 0.7 to about 19 g/10 min or less, or about 1 to about 10 g/10 min, or about 1.5 to about 5 g/10 min, or about 2 to about 4 g/10 min, as determined in accordance with ASTM method D1238 at 190° C. and 2.16 kg.

Of note are ionomers having melting point from about 45 to about 75° C. Also of note are ionomers with heat of fusion (H_{f}) of less than 12 J/g.

The acid copolymer resins may be neutralized by any conventional procedure, such as those disclosed in U.S. Pat. Nos. 3,404,134 and 6,518,365, and by other procedures that will be apparent to those of ordinary skill in the art. Some of these methods are described in detail in U.S. Pat. No. 8,334,033, issued to Hausmann et al.

### Other Components

The compositions may additionally comprise small amounts of optional materials including additives for use in polymeric materials. Examples of suitable additives include, without limitation, plasticizers, stabilizers including viscosity stabilizers and hydrolytic stabilizers, primary and secondary antioxidants such as for example IRGANOX® 1010, ultraviolet ray absorbers and stabilizers, anti-static agents, dyes, pigments or other coloring agents, fire-retardants, lubricants, processing aids, slip additives, release agents, and/or mixtures thereof. Additional optional additives may include acid copolymer waxes, such as for example Honeywell wax AC540; TiO₂, which is used as a whitening agent; optical brighteners; surfactants; and other components known in the art of golf ball manufacture to be useful but may not be critical to golf ball performance and/or acceptance. Many such additives are described in the Kirk Othmer Encyclopedia of Chemical Technology, 5^{th} edition, John Wiley & Sons (Hoboken, 2005).

Examples of fillers include metals such as titanium, tungsten, aluminum, bismuth, nickel, molybdenum, iron, steel, lead, copper, brass, boron, boron carbide whiskers, bronze, cobalt, beryllium, zinc, tin, metal oxides including zinc oxide, iron oxide, aluminum oxide, tin oxide, titanium oxide, magnesium oxide, zinc oxide and zirconium oxide, as well as other well-known corresponding salts and oxides thereof. Other commonly used fillers include barium sulfate, lead silicate, tungsten carbide, limestone (ground calcium/magnesium carbonate), zinc sulfate, calcium carbonate, zinc carbonate, barium carbonate, clay, tungsten, and mixtures of any of these.

These additives may be present in the compositions in quantities that may be from 0.01 to 15%, preferably from 0.01 to 10%, or from 0.01 to 5% of the total composition, so long as they do not detract from the basic and novel characteristics of the composition and do not significantly adversely affect the performance of the composition or golf ball prepared from the composition, particularly scuff resistance.

The optional incorporation of such conventional ingredients into the compositions may be carried out by any known process, for example, by dry blending, by extruding a mixture of the various constituents, by the conventional masterbatch technique, or the like.

The compositions described herein may be injection molded or compression molded into various shaped articles, particularly covers for golf balls as described below.

### Golf Ball Construction

The composition described herein may be used with any type of ball construction.

Suitable golf ball constructions, including one-piece golf balls, two-piece golf balls, three-piece golf balls and multi-piece golf balls, are described in U.S. Patent Application Publication 2009/0118040 and in the references cited therein. The composition described herein may be used in any of the golf balls in which the compositions described in that disclosure can be used. Of note are two-piece golf balls comprising a cover prepared from the ionomer composition described herein, and a core comprising rubber or an organic acid modified ionomer composition; wound golf balls having a cover prepared from the ionomer composition described herein.

Also noted are multi-piece golf balls having:

1. a core made of any composition, including thermoset compositions such as polybutadiene rubber or thermoplastic organic acid modified ionomer compositions, with or without filler, with a cover comprising the ionomer composition described herein; and

2. a cover prepared from the ionomer composition described herein, a core made of any composition, and at least one additional intermediate layer including intermediate layers comprising organic acid modified ionomer compositions; any layer with or without filler.

Furthermore, properties such as hardness, modulus, compression, resilience, core diameter, intermediate layer thickness and cover thickness of golf balls have been found to affect play characteristics of golf balls such as spin, initial velocity, feel and sound when struck. Depending on the construction and desired characteristics of the golf ball, the core, intermediate layers, and cover may have different resilience, compression or hardness to achieve desired performance characteristics. The compositions described herein may be useful in preparing golf balls with resilience, compression or hardness gradients within a golf ball. The selection of materials for performance based on these criteria is also described at length in U.S. Patent Application Publications US2009/0118040 and US2009/0325733 and in the references cited therein.

For a solid test sphere prepared from a single composition, the COR may depend on a variety of characteristics of the composition, including its hardness. Often it is the case with ionomers that harder resins exhibit higher COR values. However when a resin is modified with a filler, generally the hardness increases and COR decreases. In a two-piece solid golf ball with a core and a cover, one of the purposes of the cover is to produce a gain in COR over that of the core. When the contribution of the core to high COR is substantial, a lesser contribution is required from the cover. Similarly, when the cover contributes substantially to high COR of the ball, a lesser contribution is needed from the core.

Moreover, the compositions described herein have a Shore D hardness of at least about 45, such as about 50 to 60, as measured on a standard test piece. In addition, the compositions described herein preferably have a flexural modulus of about 120 to about 600 kpsi, preferably from about 180 to about 600 kpsi.

The thermoplastic compositions described herein may be useful in a wide range of objects other than covers of golf balls. The compositions also may be useful in other sporting equipment applications, particularly in golf shoe cleats, components of golf clubs such as golf club face plates or inserts, molded golf club heads, club head coatings or casings, and fillers for inner cavity of a golf club head, and the like. The compositions may be used in place of materials taught in the art for use in club faces, such as poly-imides reinforced with fillers or fibers, methyl (meth)acrylate copolymers, carbon-fiber reinforced polycarbonate, materials based on PMMA and crosslinkable monomers, and cross-linked synthetic rubber. The composition may also be substituted for the cured acrylic monomer, oligomer, polymer used to impregnate wood club heads, for rubber-like elastic cores in club heads, and for molded polyurethane club heads. As such, golf club heads may be prepared having a front striking face adapted to strike a ball and an insert mounted on the striking face, said insert comprising a molded article comprising the composition above. In addition, golf club heads comprising a metal body and an insert plate secured to the forward striking surface of the metal body and made of the composition above laminated with an outer metal layer formed with grooves. In addition, this invention also includes a golf club having a shaft with a club head affixed to the shaft, wherein the club head is described above, having a component comprising the composition above.

The composition may also be useful for preparing molded articles that are footwear structural components, provide shape support for footwear construction, such as heel counters, toe puffs, soles and cleats. “Heel counter” as used herein refers to a stiff, curved piece that provides shape and structure to the heel area of a shoe. “Toe puff” or “toe box” as used herein refers to a stiff, arched piece that provides shape and structure to the toe area of a shoe. “Sole” as used herein refers to a stiff, generally flat piece that provides shape and structure to the bottom of a shoe. These structural components may be incorporated into the internal structure of the shoe and covered with additional components for wear and/or appearance.

The composition described herein may also be useful in non-sporting good applications such as articles comprising caulking materials, sealants, modifiers for cement and asphalt, and coatings made of the composition. The compositions may also be useful in toys, decorative objects, and containers for inert materials.

The following examples are provided to describe the invention in further detail. These examples, which set forth a preferred mode presently contemplated for carrying out the invention, are intended to illustrate and not to limit the invention.

### Examples

The ethylene copolymer base resins used for Examples and Comparative Examples are shown in Table 1. Acid copolymer resins and their ionomers were obtained from DuPont under the trademarks Nucrel®, Surlyn® or SentryGlas®. Alternatively, the polymers were synthesized by the methods described in U.S. Pat. No. 8,399,096. The compositions of the synthesized polymers, which are set forth in Table 1, were determined by nuclear magnetic resonance (NMR) spectroscopy, by titration, or by mass balance methods.

As used in the Examples below, melt index (MI) refers to melt index determined according to ASTM D1238 at 190° C. using a 2160 g weight, with values of MI reported in g/10 minutes. Differential Scanning calorimetry (DSC) was used to determine melting point and heat of fusion (H_{f}) in accordance with ASTM D3418 and as described in U.S. Pat. No. 8,399,096.

In the Table, “MAA” stands for methacrylic acid, “iBA” stands for iso-butyl acrylate, “nBA” stands for n-butyl acrylate and the number refers to the weight % of the copolymerized monomer in the final polymer, with the amount of ethylene (E) in a complementary amount.

TABLE 1

| | Composition | MI (g/10 min) | M.P. (° C.) | H_{f} (J/g) |
|---|---|---|---|---|
| EAC-1 | E/22.5MAA/10iBA | 65 | 63 | 29.1 |
| EAC-2 | E/22.5MAA/10nBA | 65 | | |
| EAC-3 | E/10MAA/10iBA | 35 | | |
| EAC-4 | E/9.5MAA/23.5nBA | 25 | | |
| EAC-5 | E/6.2AA/28nBA | 210 | | |
| EAC-6 | E/15MAA | 60 | | |
| EAC-7 | E/15MAA | 25 | | |
| EAC-8 | E/19MAA | 250 | | |
| EAC-9 | E/21.5MAA/10nBA | | | |
| EAC-10 | E/22MAA/10iBA | | | 11.5 |
| EAC-11 | E/22MAA/10nBA | | | |

EAC-1, EAC-2, EAC-9, EAC-10 and EAC-11 are high acid terpolymers useful in this invention. EAC-3, EAC-4 and EAC-5 are considered low acid terpolymers used in Comparative Examples. EAC-6, EAC-7 and EAC-8 are dipolymers that provide “hard” ionomers, also used in Comparative Examples.

Ionomer compositions from EAC-1 and EAC-2 were prepared on a single screw or 30-mm twin screw extruder by treating the acid groups in the acid terpolymer base resin with metal cations and neutralizing to the indicated level to provide the Example compositions summarized in Table 2. The neutralizing agents were ZnO and/or zinc acetate for Zn ionomers, and Na₂CO₃ or NaOH for Na ionomers. For compounds containing mixed Zn and Na ions, the pure component ionomers were prepared first as described above, then the pure component ionomers were melt blended using a 30-mm twin screw extruder to generate the mixed Zn/Na ionomers. Table 2 shows the properties of the ionomers from base resins EAC-1 and EAC-2.

TABLE 2

| | Base | | MI | M.P. | |
|---|---|---|---|---|---|
| Example | Resin | % Neutralization | (g/10 min) | (° C.) | H_{f} (J/g) |
| 1 | EAC-1 | 20% Zn | 6.0 | | |
| 2 | EAC-1 | 25% Zn | 2.3 | | |
| 3 | EAC-1 | 30% Zn | 1.3 | 48.7 | 43.3 |
| 4 | EAC-1 | 25% Na | 5.5 | 69.3 | 10.3 |
| 5 | EAC-2 | 26% Na | 6.2 | 70.1 | 12.1 |
| 6 | EAC-1 | 16.7% Zn/8.3% Na | 6.1 | | |
| 7 | EAC-1 | 12.5% Zn/12.5% Na | 5.4 | | |
| 8 | EAC-2 | 16.7% Zn/8.7% Na | 5.8 | | |
| 9 | EAC-2 | 12.5% Zn/13% Na | 6.0 | | |

As Comparative Examples, ionomer compositions from terpolymers EAC-3, EAC-4, EAC-5 and were prepared on a single screw or 30-mm twin screw extruder by treating the acid groups in the acid terpolymer base resin with basic compounds comprising metal cations and neutralizing to the indicated level. Comparative Examples C3 and C4 contain AC540 (E/5AA) low molecular weight copolymer from Honeywell, and are so-called “bimodal” ionomer compositions as described in U.S. Pat. Nos. 6,562,906; 6,762,246; 7,037,967; 7,273,903 and 7,488,778 and 8,193,283. Table 3 summarizes the ionomers from terpolymer base resins EAC-3, EAC-4, and EAC-5.

TABLE 3

| Example | Base Resin | % Neutralization | Weight % AC540 | MI |
|---|---|---|---|---|
| C1 | EAC-3 | 73% Zn | 0% | 1.0 |
| C2 | EAC-4 | 52% Zn | 0% | 0.75 |
| C3 | EAC-4 | 32% Zn | 9.7% | 4.5 |
| C4 | EAC-5 | 82.5% Mg | 20% | 4.5 |

As additional Comparative Examples, ionomer compositions from dipolymers EAC-6, EAC-7, and EAC-8 were prepared on a single screw or 30-mm twin screw extruder by treating the acid groups in the acid terpolymer base resin with metal cations and neutralizing to the indicated level. For the Comparative Examples containing mixed Zn and Na ions, the pure component ionomers were prepared first as described above, then the pure component ionomers were melt blended using a 30-mm twin screw extruder to generate the mixed Zn/Na ionomer. Table 4 summarizes the ionomers from dipolymer base resins EAC-6, EAC-7, and EAC-8.

TABLE 4

| Example | Base Resin | % Neutralization | MI |
|---|---|---|---|
| C5 | EAC-6 | 53% Zn | 4.2 |
| C6 | 50% EAC-6/50% EAC-7 | 29% Zn/14.5% Zn | 1.7 |
| C7 | EAC-8 | 39% Zn | 4.5 |
| C8 | EAC-8 | 19.5% Zn/22.5% Na | 4.5 |

Examples 1-9 and Comparative Examples C1-C4 were injection molded into flex bars for mechanical property tests and neat resin spheres to test for golf ball properties.

### Thermoplastic Spheres

The compositions were molded into spheres 1.53 to 1.55 inches in diameter. For example but not limitation, injection molding conditions may include temperatures, pressures and cycle times as indicated in Table 5.

TABLE 5

| | | Injection | |
|---|---|---|---|
| | Temp (° C.) | Pressure (mPa) | Cycle Times (sec) |
| Melt | 160-260 | Packing 25-180 | Filling and Packing 40-90 |
| Mold Front/ | 10-30 | Hold 5-15 | Hold 15-30 |
| Back | | | Cooling Time 50-100 |
| | | | Screw Retraction 5-50 |

In addition, the materials were injection molded as the cover layer over a thermoplastic golf ball core to prepare golf balls of this invention. The core comprised commercial product DuPont™ HPF 2000. The density of the core material was adjusted to 1.15 g/cc (36.8 g/1.55 inch diameter sphere) by adding BaSO₄ to the composition prior to injection molding. The cores were 1.55 inches in diameter. Cover layers were deposited over the cores, also by injection molding, to provide two-piece balls with nominal diameter of 1.68 inches. The flex bars, resin spheres, and 2-piece golf balls were annealed at ambient temperature (about 20 to 22° C.) for at least two weeks following molding.

The flex bars were tested for Shore D hardness in accord with ASTM D-2240 (at 3 seconds) and flex moduli and are reported in Table 5. Flex Modulus was measured according to ASTM D790, Method 1, Procedure A, employing a 3-point test fixture with a 2-inch span length and a crosshead speed of 0.50 inches/minute. The method provides a measurement of the Tangent Modulus of Elasticity (3-Point Flex Modulus).

Three 1.55-inch spheres of each composition were tested to measure the resistance to compression. Operationally, the deflection for each sphere was measured three times upon the application of a compressive load between 0.1 and 200 pounds. All values were then averaged. The measured deflections were subsequently converted to Atti Compression using an experimentally-generated correlation between the deflection measurement described above and Atti Compression. The correlation was generated by measuring the deflection (as described using the procedure above) and the Atti Compression on three 1.55-inch neat spheres of commercially-available ionomers. Atti Compression was measured using an “Atti” testing device according to standard procedures for that instrument. For accurate comparison of Atti compression data, the diameter of the balls was corrected to 1.68-inch diameter using accepted methods, such as shimming.

Coefficient of Restitution (COR) was measured by firing an injection-molded neat sphere of the resin having the size of a golf ball from an air cannon at several velocities over a range of roughly 60 to 180 fps. The spheres struck a steel plate positioned three feet away from the point where initial velocity is determined, and rebounded through a speed-monitoring device located at the same point as the initial velocity measurement. The COR of each measurement was determined as the ratio of rebound velocity to initial velocity. The individually determined COR measurements were plotted as a function of initial velocity, and COR at 125 fps (i.e. COR₁₂₅) was determined by linear regression.

The Atti Compression and COR₁₂₅ values are reported in Table 7.

The 2-piece golf balls were tested for scuff resistance, and the scuff ratings are given in Table 5. Scuff resistance was determined in the following manner: a D-2 tool steel plate machined to simulate a sharp grooved pitching wedge with square grooves was obtained and was mounted on a swing arm that swings in a horizontal plane. The simulated club face was oriented for a hit on a golf ball at a 54° angle. The machine was operated at a club head speed of 105 feet per second. Balls were prepared as described above from each of the test compositions. Six balls of each composition were tested and each ball was hit once. After testing, the balls were rated according to the following criteria (see Table 6), and the six ratings were then averaged. Scuff damage was characterized by the presence of indented lines, lifts or groove bands. Indented lines are visible lines created by permanent displacement of the resin, but without cutting, breaking or discontinuity of the surface. Lifts are scuffs in which the resin is displaced enough that the surface is broken such that a portion of the resin is separated from the bulk of the ball. Severe lifts include flaps, whiskers or strands. Groove bands are bands of resin missing from the bulk of the ball corresponding in dimension to a single groove of the club face. The ratings were assigned numerical values based on the criteria in Table 6.

TABLE 6

| | |
|---|---|
| 0 | No sign of impact |
| 1 | One or more indented lines on a ball, but no separation of resin from |
| | the bulk of the ball. |
| 2 | One or more lifts on a ball. Resin separated from the ball on one |
| | edge but still firmly attached. |
| 3 | Severe lifts and whiskers. Flaps and strands of resin separated |
| | from the bulk of the ball but generally still attached. |
| 4 | One or more groove bands, but undamaged resin between |
| | groove bands. |
| 5 | Material missing entirely between two or more grooves bands. |

Decimal fraction ratings can be assigned between these descriptions in increments of 0.5. For example, barely visible indented lines may be rated 1.0 while deeply indented lines that push up ridges of the resin may be rated 1.5. One lift may be rated 2.0 while three or four lifts may be rated 2.5. A ball rated 3 may look more damaged than a ball rated 4 or 5 because missing material may be less noticeable than flaps and/or whiskers.

Golf balls of this invention have a scuff resistance less than or equal to 2.0 according to this rating system.

TABLE 7

| | Injection-molded | | Neat sphere | | 2- |
|---|---|---|---|---|---|
| | testpiece | | properties | | Piece Ball |
| | Shore D | Flex Modulus | Atti | | Scuff |
| Example | (3 sec.) | (kpsi) | Compression | COR₁₂₅ | Resistance |
| 1 | 50.4 | 17.6 | 93.2 | 0.594 | 2.0 |
| 2 | 51.0 | 19.1 | 111.6 | 0.612 | 1.5 |
| 3 | 54.5 | 26.5 | 116.4 | 0.621 | 2.0 |
| 4 | 62.2 | 57.1 | 153.1 | 0.727 | 1.8 |
| 5 | 62.0 | 49.6 | 149.6 | 0.721 | 2.0 |
| 6 | 59.0 | 45.5 | 145.3 | 0.698 | 1.0 |
| 7 | 61.0 | 55.1 | 151.8 | 0.719 | 1.5 |
| 8 | 58.1 | 41.3 | 147.5 | 0.695 | 1.5 |
| 9 | 60.3 | 48.9 | 150.8 | 0.714 | 1.1 |
| C1 | 49.5 | 24.4 | 120.2 | 0.595 | 5.0 |
| C2 | 34.3 | 7.2 | 43.6 | 0.583 | 0.5 |
| C3 | 31.4 | 5.5 | 36.8 | 0.506 | 0.8 |
| C4 | 34.5 | 8.8 | 67.7 | 0.690 | 3.3 |

Ionomers from terpolymers EAC-1 and EAC-2 (Examples 1-9) meet the desired hardness (Shore D of 45 to 65, preferably 50 to 65) and scuff resistance values (1 to 2.0). Examples of the invention have flex modulus from about 120 to about 600 kpsi, preferably from about 180 to about 600 kpsi. Examples of the invention have Atti compression from about 90 to about 170, preferably from about 110 to about 170. Comparative Example C1, prepared from a low acid, low acrylate copolymer, meets the hardness requirement and flex modulus requirement, but has very poor scuff resistance. Comparative Examples C2 and C3, prepared from a low acid, high acrylate copolymer have excellent scuff resistance, but do not have the desired hardness. Comparative Example C4, prepared from a different low acid, low acrylate copolymer with less acid and more acrylate, has neither adequate hardness nor scuff resistance. Comparative Examples C2, C3 and C4 have very low flex modulus and Atti compression.

Comparative Examples C2, C3, and C4 were blended with harder ionomers C5-C8 (from dipolymers) to bring the Shore D hardness to within the desired range. Hard ionomer-soft ionomer blends have been previously described as cover materials for golf balls (see for example, U.S. Pat. Nos. 4,884,814 and 5,120,791). The ionomer blends were prepared by compounding on a 30-mm twin screw extruder at the desired blend ratios. Table 8 summarizes the ionomer blends of soft and hard ionomers containing Comparative Example terpolymers C2, C3, and C4 as the soft ionomer.

TABLE 8

| | | | Weight % | |
|---|---|---|---|---|
| Example | Soft Ionomer | Hard Ionomer | of Soft Ionomer | MI |
| C9 | C2 | C5 | 33 | 0.40 |
| C10 | C2 | C6 | 33 | 1.54 |
| C11 | C3 | C5 | 33 | 2.37 |
| C12 | C3 | C6 | 33 | 2.72 |
| C13 | C3 | C7 | 33 | 4.48 |
| C14 | C3 | C8 | 33 | 6.30 |
| C15 | C4 | C5 | 33 | 1.66 |
| C16 | C4 | C5 | 50 | 2.50 |
| C17 | C4 | C6 | 33 | 2.26 |
| C18 | C4 | C7 | 33 | 8.56 |

Comparative Examples C9-C18 were injection molded into flex bars for mechanical property tests and neat resin spheres to test for golf ball properties. In addition, the materials were injection molded as the cover layer over a commercial thermoplastic golf ball core to prepare golf balls. The flex bars, resin spheres, and 2-piece golf balls were annealed at ambient temperature (about 20 to 22° C.) for at least two weeks following molding. The flex bars were tested for Shore D hardness (at 3 seconds) and flex moduli and are reported in Table 9. The resin spheres were tested for Atti compression and the coefficient of restitution and are reported in Table 9. The 2-piece golf balls were tested for scuff resistance and the scuff ratings are given in Table 9.

TABLE 9

| | Injection-molded | | Neat sphere | | 2- |
|---|---|---|---|---|---|
| | testpiece | | properties | | Piece Ball |
| | Shore D | Flex Modulus | Atti | | Scuff |
| Example | (3 sec.) | (kpsi) | Compression | COR₁₂₅ | Resistance |
| C9 | 49.3 | 31.1 | 125.3 | 0.658 | 4.0 |
| C10 | 52.3 | 37.7 | 135.9 | 0.708 | 3.3 |
| C11 | 48.9 | 30.7 | 128.4 | 0.641 | 4.0 |
| C12 | 52.1 | 38.1 | 139.1 | 0.695 | 2.8 |
| C13 | 47.8 | 31.1 | 125.3 | 0.635 | 2.5 |
| C14 | 54.9 | 49.5 | 140.7 | 0.725 | 2.4 |
| C15 | 50.4 | 36.3 | 133.2 | 0.701 | 2.9 |
| C16 | 47.6 | 25.8 | 116.6 | 0.682 | 3.8 |
| C17 | 51.0 | 37.9 | 134.2 | 0.715 | 2.6 |
| C18 | 49.4 | 40.1 | 127.9 | 0.690 | 2.3 |

The ionomer blends C9-C18 all meet the hardness requirement for the invention, but have poor scuff resistance. Flex modulus was also low for C9-C18.

The terpolymers of the invention can be blended with softer ionomers without deteriorating the scuff performance. To demonstrate, Example 3 was blended with softer ionomer C3 at a 75/25 ratio of 3/C3. The blend of 3/C3, Example 19, was prepared by compounding on a 30-mm twin screw extruder at the desired blend ratio. Table 10 shows the properties of the ionomer blend, illustrating that the scuff resistance is not deteriorated. Flex modulus, Atti compression and COR₁₂₅ were also maintained within desired ranges.

TABLE 10

| | Injection-molded | | Neat sphere | | 2- |
|---|---|---|---|---|---|
| | testpiece | | properties | | Piece Ball |
| | Shore D | Flex Modulus | Atti | | Scuff |
| Example | (3 sec.) | (kpsi) | Compression | COR₁₂₅ | Resistance |
| C3 | 31.4 | 5.5 | 36.8 | 0.506 | 0.8 |
| 3 | 54.5 | 26.5 | 116.4 | 0.621 | 2.0 |
| 19 | 46.6 | 19.6 | 102.7 | 0.576 | 2.0 |

Compared to a prior art hard ionomer/soft ionomer blend of similar hardness (C16), the blend of this invention had comparable flex modulus and significantly better scuff resistance.

1. A golf ball comprising a core and a cover and optionally at least one intermediate layer positioned between the core and the cover, wherein the cover comprises an ionomer of an ethylene acid copolymer comprising copolymerized units of ethylene, about 15 to about 30 weight % of copolymerized units of a C₃₋₈ α,β-ethylenically unsaturated carboxylic acid, and about 3 to about 13 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 30% to carboxylate salts comprising alkali metal ions, alkaline earth ions, transition metal ions or combinations thereof.

2. The golf ball of claim 1 wherein the ethylene acid copolymer comprises copolymerized units of about 67.5 weight percent of ethylene, about 22.5 weight percent of methacrylic acid and about 10 weight percent of n-butyl acrylate.

3. The golf ball of claim 1 wherein the ethylene acid copolymer comprises copolymerized units of about 68.5 weight percent of ethylene, about 21.5 weight percent of methacrylic acid and about 10 weight percent of n-butyl acrylate.

4. The golf ball of claim 1 wherein the carboxylate salts comprise zinc ions, sodium ions or a combination thereof.

5. The golf ball of claim 1 wherein the composition of the cover further comprises an additional ionomer of an ethylene acid copolymer comprising copolymerized units of ethylene, about 3 to about 12 weight % of copolymerized units of a C₃₋₈ α,β-ethylenically unsaturated carboxylic acid, and about 15 to about 30 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 70% to carboxylate salts comprising alkali metal ions, alkaline earth ions, transition metal ions or combinations thereof.

6. The golf ball of claim 5 wherein the additional ionomer comprises about 3 to about 12 weight % of copolymerized units of acrylic acid or methacrylic acid and about 15 to about 30 weight % of copolymerized units of alkyl acrylate or alkyl methacrylate.

7. The golf ball of claim 6 wherein the additional ionomer comprises about 3 to about 12 weight % of copolymerized units of methacrylic acid and about 15 to about 30 weight % of copolymerized units of n-butyl acrylate.

8. The golf ball of claim 1 wherein the core comprises polybutadiene rubber or a thermoplastic organic acid modified ionomer composition.

9. The golf ball of claim 1 wherein the intermediate layer is present and comprises a thermoplastic organic acid modified ionomer composition.

10. A composition comprising an ionomer of an ethylene acid copolymer comprising copolymerized units of ethylene, about 15 to about 30 weight % of copolymerized units of a C₃₋₈ α,β-ethylenically unsaturated carboxylic acid, and about 3 to about 13 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 30% to carboxylate salts comprising alkali metal ions, alkaline earth ions, transition metal ions or combinations thereof.

11. The composition of claim 10 wherein the ethylene acid copolymer comprises copolymerized units of about 67.5 weight percent of ethylene, about 22.5 weight percent of methacrylic acid and about 10 weight percent of n-butyl acrylate.

12. The composition of claim 10 wherein the ethylene acid copolymer comprises copolymerized units of about 68.5 weight percent of ethylene, about 21.5 weight percent of methacrylic acid and about 10 weight percent of n-butyl acrylate.

13. The composition of claim 10 wherein the carboxylate salts comprise zinc ions, sodium ions or a combination thereof.

14. The composition of claim 10 further comprising an additional ionomer of an ethylene acid copolymer comprising copolymerized units of ethylene, about 3 to about 12 weight % of copolymerized units of a C₃₋₈ α,β-ethylenically unsaturated carboxylic acid, and about 15 to about 30 weight % of copolymerized units of a softening comonomer selected from the group consisting of vinyl acetate, alkyl acrylate and alkyl methacrylate; wherein the acid moieties in the acid copolymer are nominally neutralized to a level from about 15% to about 70% to carboxylate salts comprising alkali metal ions, alkaline earth ions, transition metal ions or combinations thereof.

15. The composition of claim 14 wherein the additional ionomer comprises about 3 to about 12 weight % of copolymerized units of acrylic acid or methacrylic acid and about 15 to about 30 weight % of copolymerized units of alkyl acrylate or alkyl methacrylate.

16. The composition of claim 15 wherein the additional ionomer comprises about 3 to about 12 weight % of copolymerized units of methacrylic acid and about 15 to about 30 weight % of copolymerized units of n-butyl acrylate.
